(19) United States
(12) Patent Application Publication
(10) Pub. No.: US 2002/0104390 A1
(43) Pub. Date: Aug. 8, 2002

(54) Apparatus and method for mounting analysis equipment on a vehicle

(76) Inventor: Barbara L. Jones, King's Lynn (GB)

Correspondence Address: Harold V. Stotland, Seyfarth Shaw, Suite 4200, 55 East Monroe Street, Chicago, IL, 60603-5803, US

(21) Appl. No.: 09/775,461

(22) Filed: Feb. 5, 2001

(51) Int. Cl. G08C 19/06

(52) U.S. Cl. 73/866.5; 73/865.9; 340/870.05

(57) ABSTRACT

An apparatus and method for three-dimensional coordinate determination adapted for automotive crash repair and diagnostics includes coordinate data evaluation equipment having transmitter means and receiver means, one of which is disposed at plural locations on the vehicle and the other of which is fixed relative to the vehicle. A frame has an elongated upright member along which mounting assemblies are selectively positionable, each mounting assembly including a clamp moveably receiving a lateral member therethrough for selective lateral positioning therealong. Suction cups are fixed to one lateral member for a mounting on the vehicle and a suitable clamp is mounted on the other lateral member for attachment to the fixed part of the associated analysis equipment.

### BACKGROUND

This application relates to a method and apparatus for mounting and an embodiment of particular (but not exclusive) utility. In particular, it relates to the use of such a method and apparatus for mounting measurement apparatus applicable to the dimensional and/or geometric analysis of automotive vehicles and/or portions thereof, particularly, but not exclusively in relation to the analysis of and/or remedial action upon such automotive vehicles and/or parts thereof after damage or impact involving non-elastic deformation of at least part of the structure thereof.

Many proposals exist for systems in which automotive vehicles and/or parts thereof are subjected to dimensional analysis in order to assist the taking of remedial steps after damage by impact or the like. One such proposal is disclosed in WO 98/11405 (Brewco) in which a system for measuring the points on a vehicle includes reference emitters fixed relative to the vehicle. Electromagnetic radiation-emitting probes and a camera and a computer are used. The camera senses the direction of the emitters from three different locations so that the computer can triangulate the data to determine the position of the emitters. The position data is then put onto a standard coordinate system and is compared to standard data for the type of vehicle to determine the extent of deviation of the measured point from the standard data. This provides real time data to a person who is straightening the vehicle or aligning parts of the vehicle whereby the completion of such straightening can be determined.

In a modification of the WO 405 system, probes with light-emitting diodes are linked to a reference frame which is mounted on the vehicle chassis or frame in order to provide a positional and dimensional reference base for reference purposes. The usual technique is to clamp the reference frame to the vehicle by the use of clamps actuated by alien keys engaging the pinchweld region of the vehicle sill, since this provides an accessible and relatively positionally-stable and defined reference basis for dimensional and geometrical analysis.

However, certain vehicles do not include a suitable mounting for the reference frame in terms of an accessible structure such as a pinchweld, and this represents a significant problem in providing a secure and well-defined mounting for the structure to be used for positional and/or dimensional and/or geometrical analysis.

There is disclosed in U.S. Pat. No. 6,069,966 at FIG. 9 a system for mounting a sensing head on a vehicle in relation to a tyre thereof for analysis of tyre tread and sidewall condition. The apparatus of this FIG. 9 is provided in order to enable the analysis of tyre condition to be made in situ on the vehicle without detachment of the tyre from the vehicle and while the tyre is rotated on the vehicle during vehicle travel. There is no disclosure nor suggestion in the drawing or description relating to the said FIG. 9 that this structure could provide anything other than a convenient mounting for tyre tread imaging apparatus adapted to monitor tread condition as the vehicle travels.

There is disclosed in U.S. Pat. No. 4,811,250 a system for acoustic-based three-dimensional coordinate analysis as applied to automotive vehicles in which acoustic signals from transmitter means at a series of defined locations are received by acoustic receiver means located at a temporarily fixed location throughout a series of measurements and connected to data processing means whereby a time-based determination of the coordinates of each of the reference locations is made by a calculation technique utilizing the acoustic signal transmission time differential for two transmitters at each location of known spacing from each other at that location, and by reference to a simple triangulation technique. This represents a typical example of apparatus to which the present invention may be applied, and we hereby incorporate in the present application by reference the entire disclosure of U.S. Pat. No. 4,811,250.

There is disclosed in U.S. Pat. No. 4,523,384 a system for direct dimensional analysis of the underside of a vehicle in which a reference frame is mounted below the vehicle by means of conventional gripper-type fastening devices so that from the reference frame direct measurements can be made by conventional contact-based analogue-type measurement devices. The gripper devices engage and grip suitable structures (if they can be found) at the underside of the vehicle. It will be appreciated that all systems of the kind disclosed in the U.S. Pat. No. 4,523,384 which involve attachment to the underside of the vehicle inevitably require the user to raise the vehicle for access to the underside or else to position the vehicle over a pit or the like providing access to the underside. While it may be accepted that access to the vehicle underside is usually a requirement for the actual measurement steps in automotive three dimensional mapping techniques, it is clearly a much to be desired advance if the extent to which work on the vehicle underside involving selective mounting or cooperation of appliances is minimized.

Likewise, in published specifications such as U.S. Pat. No. 4,811,250, mentioned above, and EP 0,598,809 B1, use of the systems on any one particular vehicle under test requires the use of an absolutely constant position for the receiver system (comprising acoustic microphones) relative to the vehicle and yet no means is provided for avoiding accidental nudging or kicking or otherwise at least slightly moving the receiver unit after measurements have commenced and such represents a significant risk in relation to use of the system and it would represent a significant advance if this could be eliminated or reduced.

### SUMMARY

An object of the subject matter described herein is to provide improvements in relation to the provision of mounting means for apparatus applicable to dimensional and/or geometrical and/or positional analysis of automotive vehicle structures having regard to matters discussed above or elsewhere herein and/or improvements generally in relation thereto.

In an embodiment there is provided a method and apparatus in which quick-attach and disconnect attachment means is provided and is adapted to provide a mounting for apparatus forming at least part of dimension and/or geometrical and/or positional analysis of automotive vehicles or parts thereof. In the embodiment, the quick attach and disconnect attachment means is adapted to cooperate with the external bodywork of the vehicle. For this purpose, suction means may be provided and/or magnetic means likewise. Related attachment means may likewise be used which are capable of providing a secure means of attachment, while not requiring the use of permanent adhesive or fasteners of the kind requiring penetration of the surface with which they coact.

An embodiment maybe devised in which use of suitable peelable adhesives may enable rapid attachment and a sufficiently secure temporary mounting while permitting relatively rapid removal without damage to the surface of the vehicle.

By adopting the approach in which the mounting mens is secured to the vehicle by attachment to the external body work using an attachment means not requiring gripping (as in the case of the clamps applied to the pinch welds) and yet which is able to provide the degree of security of mounting which precision remedial action on motor vehicles requires, and yet does not require any penetration of the vehicle superstructure nor yet results in any appreciable harm to the surface finish thereof, the embodiments provide a notable advance. Not only is the need for the mounting of a reference frame by the use of camp structures applied to an under surface of the vehicle avoided, but also the disadvantage that certain vehicles do not possess any suitable structure with which the provided clamps can cooperate in a conventional clamp-gripping action, is avoided.

In the embodiments, the mounting system provides a two-ended structure having at one end the mounting means for the relevant parts or components of the measurement apparatus, and at the other end the quick-attach and disconnectable attachment means for cooperation with the external or bodywork or superstructure of the vehicle. Connecting these end regions is a structurally strong (with respect to the loads applied to it) bridge or arm which serves to ensure structural and positional integrity of the system once mounted on the vehicle. This bridge or arm structure between the mounting ends of the apparatus itself offers operational advantages in terms of enabling the user to position the mounting of the measurement apparatus at a convenient (and effectively extended) location which is well-suited to the purposes of the positional analysis process. Whereas the previously-proposed system of mounting the reference frame with respect to the pinch weld of the vehicle sill required the frame to be located at a relatively restricted range of locations, the embodiments of the present invention enable relatively complete freedom to be adopted, since the connection of the quick-attached means at the other end of the structure to the vehicle bodywork can be arranged to cooperate with that body work at any one of a large range of suitable points on the body work, each of which corresponds to a different position for the other end of the apparatus. Means may even be provided for enabling the bridge or arm structure to incorporate means such as a lockable ball or other joint to introduce further flexibility in this later regard.

In the embodiment, the provision of flexibility of orientation and position is provided by means of simple positional adjustment devices identified in the embodiment as vertical and horizontal orientation clamps. These are provided at both ends of the tube (designated upright tube) constituting the bridge or arm structure between the vehicle-mounting and apparatus-mounting ends of the equipment.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a diagrammatic illustration of a vehicle with an embodiment of a three-dimensional coordinate determination apparatus mounted thereon;

FIG. 2 is a diagrammatic view of the underside of a vehicle showing locations of transmitter means supported thereon and illustrating the receiver and associated mounting means of FIG. 1;

FIG. 3 is a front elevational view of an embodiment of a mounting apparatus; and

FIG. 4 is a side elevational view of the apparatus of FIG. 3.

### DETAILED DESCRIPTION

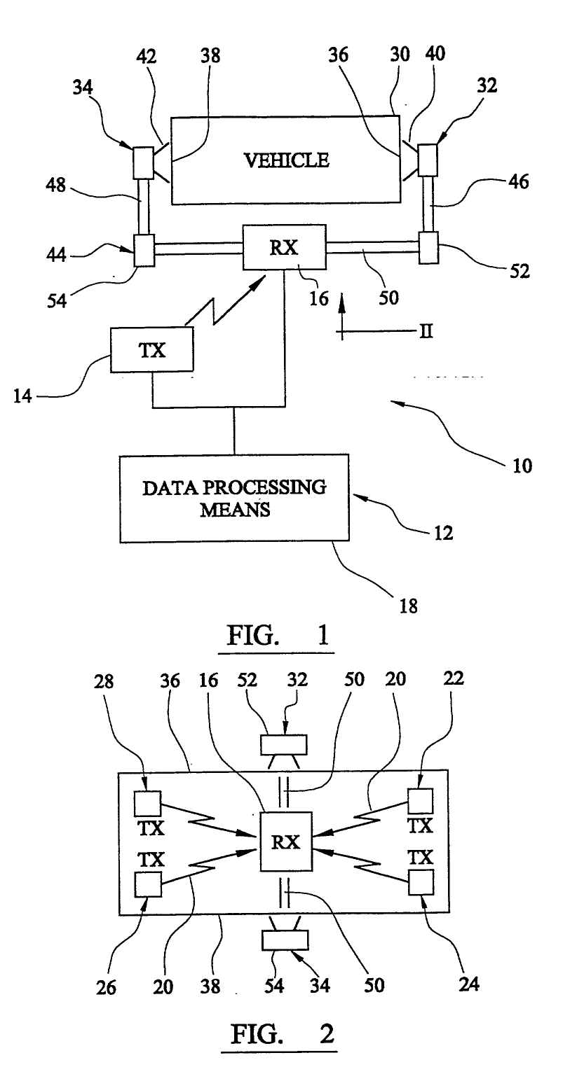

As shown in FIGS. 1 and 2 of the drawings, apparatus 10 for three-dimensional coordinate determination and adapted for automotive crash repair and diagnostics comprises data evaluation apparatus 12 comprising transmitter means 14 and receiver means 16 and data processing means 18 adapted to process data derived from the transmission of an energy signal 20 between the transmitter and receiver means 16, 18 to determine information with respect to the three-dimensional coordinates of one of the transmitter means and the receiver means 14, 16 (in this case the transmitter means 14), with respect to the other thereof (in this case the receiver means 16).

In use, the data evaluation apparatus 12 is used to carry out a series of coordinate data evaluation steps in which one of the transmitter and receiver means 14, 16 (in this case the transmitter means 14) is applied to a series of identifiable locations 22, 24, 26, 28 (see FIG. 2). In FIG. 2 only four such locations have been shown, but in practice many more such locations are employed, as disclosed for example in the above-mentioned U.S. Pat. No. 4,811,250. Energy signals 20 are transmitted from transmitter means 14 to receiver means 16 while data evaluation steps are carried out. Usually, the steps of transmission and receiving and data evaluation are carried out from the locations 22 to 28 in sequence. It is an important requirement of the process that the receiver means 16 is maintained at a constant position with respect to automotive vehicle 30 throughout these steps, and for this purpose there is provided a pair of quick-attach mounting means 32, 34 adapted to be attached to the generally smooth surfaces of panel means 36, 38 at the sides or front or rear of upper exterior surfaces of the body panels of vehicle 30, whereby the mounting means 32 34 are attached to the vehicle. In this embodiment, the quick attach mounting means comprising the resilient suction cup means 40, 42 is adapted to be detachably adhered to the panel means 36, 38 by inward loading, consequential expulsion of air from within the cups, and subsequent resilient action of the cup means, whereby pressure reduction within the chamber defined by the cups and the body panels causes the cups to be held to the body panels.

As also shown in FIGS. 1 and 2, apparatus 10 further comprises a frame or like structure 44 adapted to interconnect the pair of quick-attach mounting means 32, 34 and to extend downwardly (see FIG. 1) (or upwardly or laterally from each one of the quick attach mounting means) at the side locations of the vehicle at which the mounting means are provided and then to extend across the underside of the vehicle and to be joined to the corresponding structure connected to the other one of the quick-attach mounting means so as to form the generally unshaped structure seen, diagrammatically, in FIG. 1. In FIG. 1, the frame or like structure 44 extends below the body of vehicle 30, but above the ground level (not shown) on which the vehicle is supported by its ground wheels (also not shown).

Thus, the frame or like structure 44 provides a fixed and stable mounting structure on the vehicle and on which the receiver means 16 (acoustic microphone or camera) is mounted so as to be able to communicate with transmitter means 14 via energy signals 20, as indicated in FIG. 2. In simple terms, the frame or like structure 44 hangs from suction cups 40, 42 attached to the body panels 36, 38 so that receiver means 16 is supported in a stable manner from the structure of the vehicle for signal receptor purposes.

Frame or like structure 44 comprises downwardly-extending frame members 46, 48 and a transverse frame member 50, these frame members being structurally connected by joints 52, 54. Receiver means 16 is mounted on transverse frame member 50 through adjustable connection means (not shown) permitting attitude adjustment of the receiver means with respect to the transverse frame member 50.

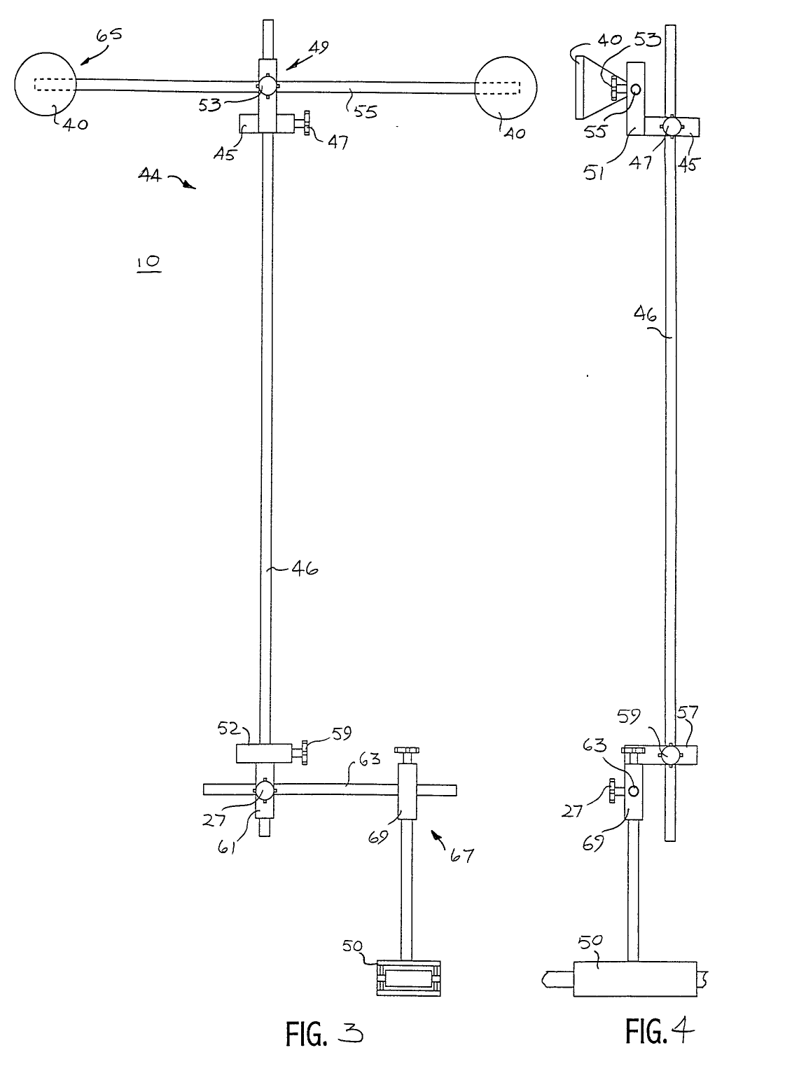

Referring to FIGS. 3 and 4, there is illustrated additional structural details of one side of the frame 44 having the upright member 46, parts of the frame 44 corresponding to those in FIGS. 1 and 2 having the same reference numbers. Elongated upright member 46 may have any desired transverse cross-section and may be solid or hollow. The frame 44 includes a clamp 45, which may be in the nature of a collar slidably receiving the upright member 46 therethrough, and provided with locking structure, such as a set screw 47, for fixing the clamp 45 at a predetermined position along the upright member 46. The clamp 45 forms part of a mounting assembly 49, which further includes a clamp 51 suitably fixed to the clamp 45. The clamp 51 may be in the nature of a collar provided with a locking structure, such as a set screw 53, and adapted to slidably receive therethrough an elongated lateral member 55, which may be in the nature of a hollow tubular member.

The frame 44 is also provided with a clamp 57, which may be similar to the clamp 45 and is provided with a set screw 59 and is adapted for slidably receiving the upright member 46 therethrough. The clamp 57 forms part of a mounting assembly 59, which includes a clamp 61 suitably fixed to clamp 57 and provided with a locking mechanism, such as a set screw 61, and adapted for slidably receiving therethrough an elongated lateral member 63, which may be similar to the lateral member 55.

The frame 44 also includes a mounting structure 65, which may include a plurality of suction cups 40 suitably secured to the lateral member 55 at spaced-apart location therealong and adapted for attachment to the outer surface of an associated vehicle (not shown) for fixedly securing the frame 44 thereto. The frame 44 also includes a mounting structure 67, which may include a standard sill clamp 69, mounted to the lateral member 63, either fixedly or for movement laterally therealong, the sill clamp 69 being coupled to a reference frame such as transverse frame 50. The reference frame 50 may support associated analysis equipment, such as the receiver 16, applicable to the dimensional and/or geometric analysis of automotive vehicles and/or portions thereof, particularly, but not exclusively, in relation to the analysis of and/or remedial action upon such automotive vehicles and/or parts thereof after damage or impact involving non-elastic deformation of at least part of the structure thereof.

In the disclosed embodiment, quick-attach and disconnect mounting structure is provided by the suction cups 47, which may be constructed of a suitable polymeric material, whereby rapid and straightforward mechanical connection using the suction-action readily generated enables the mounting structure to be instantly secured to the body work of an automotive vehicle, for example the exterior side faces of the door panels.

Thus, in use, the apparatus is suspended from the suction cups with the upright member 46 extending downwardly to a level below the vehicle sills, where the lower horizontal orientation clamp 57 and associated lateral member 63 provide a mounting for the reference frame 70, so that the latter can readily support the relevant portions of the analysis equipment applicable to the dimensional and/or geometric and/or positional analysis of the automotive vehicle. It will be understood that the suction cups 40, in association with the vertical and horizontal orientation clamps 45, 51, 57 and 61, enable considerable freedom of positional adjustment for the mounting of the reference frame 70 and its associated equipment, whereby the vehicle analysis equipment, for example as disclosed in the WO 405 specification, can be appropriately mounted for analytical purposes.

The other side of the frame 44, including the upright member 48 and suction cups 42 may be substantially the same as the side described above and will not be further described here.

It will be understood that the mounting method and apparatus of the invention is applicable to any system of automotive vehicle apparatus for measurement applicable to the dimensional and/or geometric and/or positional analysis of the vehicle and is not in any way limited to the system as disclosed in the WO 405 specification. The technically competent person will appreciate that alternatives to the suction cups may be devised and substituted, and likewise for the structures interconnecting the suction cups and the reference frame.

In use, the apparatus 10 is typically oriented with the upright members 46, 48 disposed substantially vertically. It will be appreciated that, when so arranged, the mounting structure 65 is movable vertically along the upright member 46 by a reason of the clamp 45 and is moveable horizontally with the lateral member 55 by reason of the clamp 51. Similarly, the mounting structure 67 is moveable vertically along the upright member 46 by reason of the clamp 57 and is moveable horizontally with the lateral member 63 by reason of the clamp 61 or along the lateral member 63 by reason of the clamp 69. Thus, the analysis equipment can be easily adjusted relative to a selected mounting position on the associated vehicle. While collar clamps with set screws have been illustrated, it will be appreciated that other types of clamping devices, such as those with quick-acting cam-type locking mechanisms of known designs, could be used.

In use, the method and apparatus are employed in the manner generally as indicated above. The apparatus shown in FIGS. 1 and 2 is mounted in relation to vehicle 30 and a series of coordinate determination steps are carried out at positions 22, 24, 26 and 28 with receiver 16 in its fixed position as shown. The coordinates are utilized in relation to diagnostic or crash repair operations in the manner described in the above-identified U.S. Pat. No. 4,811,250, or in the manner established in relation to other related systems. Receiver 16 is maintained in its stable and fixed position throughout a given series of coordinate determinations without any significant risk of accidental movement by the operator, due to its stable and fixed position on frame 44.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

What is claimed is:

1. Apparatus for three-dimensional coordinate determination adapted for automotive crash repair and diagnostics, the apparatus comprising:
coordinate data evaluation equipment including transmitter means and receiver means and data processing means adapted to process data derived from the transmission of an energy signal between the transmitter means and the receiver means to determine information with respect to the three-dimensional coordinates of one of the transmitter means and said receiver means with respect to the other thereof,
the one of the transmitter means and the receiver means being disposable at a series of predetermined locations on a vehicle while the energy signal is transmitted and the other of the transmitter means and the receiver means being disposable at a fixed location relative to the vehicle,
first and second quick-attach mounting structures adapted to be mounted at spaced-apart mounting locations on the vehicle, and
a frame interconnecting the quick-attach mounting structures and supporting the other of the transmitter means and the receiver means in a fixed and stable position.

2. The apparatus of claim 1, wherein the quick-attach mounting structure includes suction cups.

3. Apparatus of claim 1, wherein the mounting locations are opposed locations on the vehicle.

4. The apparatus of claim 3, wherein the frame extends across the vehicle.

5. The apparatus of claim 4, wherein the frame extends beneath the vehicle.

6. The apparatus of claim 1, wherein the receiver means is mounted on the frame and the transmitter means includes a plurality of transmitters respectively disposed at the series of predetermined locations on the vehicle.

7. The apparatus of claim 1, wherein the frame includes portions interconnected for adjustment along mutually perpendicular axes.

8. A method of three-dimensional coordinate determination adapted for automotive crash repair and diagnostics, the method comprising:
providing coordinate data evaluation apparatus including transmitter means and receiver means and data processing means adapted to process data derived from the transmission of an energy signal between the transmitter means and the receiver means to determine information with respect to the three-dimensional coordinates of one of the transmitter means and the receiver means with respect to the other thereof,
applying one of the transmitter means and the receiver means to a series of predetermined locations on a vehicle,
mounting the other of the transmitter means and the receiver means at a fixed location relative to the vehicle by use of quick-attach mounting structures applied to an external surface of the vehicle at spaced-apart mounting locations thereon, and
carrying out a series of coordinate data evaluation steps with the apparatus by transmitting the energy signal from the transmitter means to the receiver means while the transmitter means and the receiver means are mounted on the vehicle.

9. The method of claim 8, wherein the other of the transmitter means and the receiver means is mounted on the vehicle by the use of suction cups.

10. The method of claim 8, wherein the quick-attach mounting structures are attached to opposed mounting locations on the vehicle.

11. The method of claim 10, wherein the other of the transmitter means and the receiver means is supported between the opposed mounting locations.

12. The method of claim 8, wherein the transmitter means is applied to the series of predetermined locations on the vehicle and the receiver means is supported from the quick-attach mounting structures.

13. Apparatus for mounting three-dimensional coordinate determination equipment on a vehicle comprising:
a frame including first members extending in a first direction and second members movably coupled to the first members and extending in a second direction substantially perpendicular to the first direction,
first mounting structure adapted for mounting on the vehicle,
second mounting structure adapted for connection to the equipment, and
coupling mechanism for coupling the first and second mounting structures to the frame for accommodating movement of the first and second mounting structures relative to each other in each of the first and second directions.

14. The apparatus of claim 13, wherein the first mounting structure includes apparatus for coupling to an associated vehicle without damage to or alteration of the vehicle.

15. The apparatus of claim 14, wherein the first mounting structure includes suction cups.

16. The apparatus of claim 13, wherein the coupling mechanism includes clamps for releaseably gripping the frame.

17. Apparatus for mounting analysis equipment on a vehicle comprising:
an elongated upright member,
a first mounting assembly coupled to the upright member for movement longitudinally therealong,
said first mounting assembly including a first lateral member,
first mounting structure adapted for mounting on the vehicle and coupled to the first lateral member for movement therealong,
a second mounting assembly coupled to the upright member for longitudinal movement therealong,
the second mounting assembly including a second lateral member, and
second mounting structure adapted for connection to the analysis equipment and coupled to the second lateral movement for movement therealong.

18. The apparatus of claim 17, wherein the upright member is disposed in use substantially vertically.

19. The apparatus of claim 17, wherein the first mounting structure includes suction cups.

20. The apparatus of claim 17, wherein each of the first and second mounting assemblies includes clamps respectively slidably moveable along the upright and lateral members and fixable at predetermined positions therealong.
